(19) United States
(12) Patent Application Publication
(10) Pub. No.: US 2004/0195861 A1
(43) Pub. Date: Oct. 7, 2004

(54) Impact energy absorbing device for vehicles

(76) Inventors: Lutz Ristow, Tomerdingen (DE); Matthias Nohr, Esslingen (DE)

Correspondence Address: HOWREY SIMON ARNOLD & WHITE, CITYPOINT, ONE ROPEMAKER STREET, LONDON, EC2Y 9HS, GB

(21) Appl. No.: 10/415,433

(22) PCT Filed: Oct. 31, 2001
(86) PCT No.: PCT/EP01/12610

(30) Foreign Application Priority Data
Nov. 3, 2000 (DE) 100 55 876.3

(51) Int. Cl. B60J 7/00

(52) U.S. Cl. 296/187.03

(57) ABSTRACT

The invention relates to an impact energy absorbing device for vehicles. The invention is suited, but not limited to, for use in rail vehicles. The aim of the invention is to provide an impact energy absorbing device, which also fulfils future requirements with regard to crash safety. In order to enable a larger working travel without having to increase the amount of force, the energy absorbing process is spatially displaced. The impact energy absorbing device comprises activatable or deactivatable means for absorbing impact energy. In one embodiment a front part of the rail vehicle is extended, swung out and/or pushed out counter to the direction of impact especially counter to the direction of travel, when these means are activated, and afterwards, the produced space is at least partially, in particular, completely filled with energy absorption elements. In another embodiment, which can also be combined with the aforementioned embodiment, spaces which exist at least between two adjacent and interspaced parts of the vehicle, in particular between two cars of a train, are at least partially, in particular, completely filled with energy absorption elements when the means for absorbing impact energy are activated.

The invention relates to an impact-energy dissipation device for vehicles according to the preamble of claim 1. The invention is suitable for—but not restricted to —use in rail-bound vehicles.

Multiple-unit trains without locomotive, such as for example the ICE, are according to the state of the art rigidly connected train sets, the energy absorption devices of which are located in the couplings and/or buffers at the ends of the train and between the individual carriages. In the event of a collision with an obstruction, a collision of the carriages onto one another and a deformation in the front area occurs after the coupling absorbers have been utilised. In consequence, high passenger acceleration with corresponding serious personal injuries and considerable structural damage to the carriages or trains are to be expected. Increasingly stringent demands will be made in future on the crash safety of, for example, electrically operated or diesel-operated multiple-unit trains. The magnitude of the crash energy to be dissipated is determined by the parameters of mass and speed. The deformation work to be performed arises from the parameters of force and path. The force is as a rule limited by historically defined load assumptions (UIC 566/DIN EN 12663) such as for example 1500 kN compressive force on the coupling support. As uniform a distribution as possible of the force on the carriage cross-section has design limits and is possible only to a limited extent. Dimensioning the carriage body and its cross-section for larger load assumptions has both economic limits, as well as limits as regards weight.

In the past, rigidly mounted dissipation devices have been fixed to the rail-bound vehicle, which devices are deformed reversibly or irreversibly and thereby dissipate the crash energy, i.e. deformation work is performed and the kinetic energy is converted into heat. In the case of spring-mounted dissipation devices, e.g. buffers, the crash energy is stored in the spring elements and then also converted into heat.

The drawback with these solutions is the limited absorption capacity for impact energy to be dissipated. An increase in the absorption capacity is limited on the one hand by the weight and on the other hand by the dimensions of the dissipation devices and the vehicle. This would in addition be associated with increased costs in production and in operation.

Furthermore, the external design restricts the assembly space for dissipation devices or the external design has to be changed to take account of the dissipation devices. DE 197 05 226 A1 describes an excess impact-energy dissipation device for rail-bound vehicles, with which, via a trigger mechanism, excess impact-energy dissipation elements are displaced forwards outside the front contour of the vehicle against the impact direction and come into contact with similar excess impact-energy dissipation elements of coupled neighbouring vehicles. The drawback here is that the path over which the energy dissipation elements can be displaced against the impact direction is limited. It amounts at most to the distance between two coupled neighbouring vehicles in the area of the energy dissipation elements. As a result, the absorption capacity for impact energy to be dissipated is also very limited. DE 32 28 941 A1 describes a device for absorbing excessive impacts incorporated after a central buffer coupling. A climbing protection device fixed above the central buffer coupling is fixed to an impact rod, which is fixed to an under frame with the interposition of an excess-impact safety device and supports the central buffer coupling by means of a crosspiece. The impact surface of the trumpet projects beyond the impact surface of the climbing protection device by a defined distance, which corresponds to the depth of compression of the device. The distance from the climbing protection device to the front face of the vehicle is greater than the depth of compression of the excess-impact safety device. The drawback here is the small absorption capacity for impact energy to be dissipated. DE 36 32 578 A1 discloses a buffer impact-energy dissipation device, in particular for urban traffic rail-bound vehicles, with a primary energy dissipation device integrated into a central buffer coupling and absorbing the buffer forces occurring during driving and shunting mode and a secondary energy dissipation device absorbing the impact energy resulting from excessive buffering impacts. A horizontal, essentially straight transverse coupling support is arranged here in a longitudinally displaceable manner in the vehicle head piece, which in the longitudinal axis of the vehicle supports the central buffer coupling in an articulated manner and at the sides, close to its transverse ends, the secondary energy dissipation device. Here too, the drawback is the small absorption capacity for impact energy to be dissipated. The absorbers cannot be adapted to a crash incident, but merely fulfil specific requirements.

This problem is solved by an impact-energy dissipation device according to the features of claim 1.

Expedient configurations and developments of the invention are given in the sub-claims.

All previously known impact-energy dissipation elements or systems make no distinction between dimension and function at the end of the train and between coupled carriages of a train. Only the path between the coupling surface and/or the buffer surface and the beginning of the interior driver's space is as a rule available as a work path for the crash energy to be dissipated in a crash. An extension of the head in front of the driver's cabin impairs the driver's field of vision and lengthens the train without improving the transport performance. In order to enable a greater work path without having to increase the force, the energy dissipation process is therefore spatially displaced according to the invention.

Since the level of the amount of absorbable energy E is determined by the parameters force F and path s according to the equation E=F·s and the maximum sustainable force level for rail-bound vehicles is limited, the invention aims at an efficient utilisation of already existing distances between carriage bodies and/or the lengthening of the utilisable path for absorption elements in the front area of the rail-bound vehicle.

The impact-energy dissipation device according to the invention has means of impact-energy absorption, whereby these are capable of being activated or deactivated.

In one form of embodiment, when the means of impact absorption are activated, a front part of the vehicle is moved out, swivelled out and/or pushed out against the impact direction, in particular against the travel direction, and the intermediate space created by moving out, swivelling out and/or pushing out the front part is then filled at least partially, in particular fully, with energy absorption elements.

In a further form of embodiment which can also be combined with the aforementioned form of embodiment, when the means of impact absorption are activated, intermediate spaces existing at least between two neighbouring and spaced parts of the vehicle, in particular between two carriages of a train, are filled at least partially, in particular fully, with energy absorption elements.

The invention is not restricted to a special form of embodiment of the dissipation elements. Primary and/or secondary dissipation elements working both reversibly and irreversibly are possible.

The advantages of the invention consist in the fact that higher impact-energy amounts can be absorbed by making available an increased energy absorption path. Furthermore, higher impact energy can be absorbed distributed over the train. An adaptation to the detected crash incident takes place. Passenger safety is thus increased. The carriage body structure is damaged less or not at all, so that a subsequent repair time is shortened by simple replacement of absorber modules containing the energy absorption elements. Furthermore, it is advantageous that the future crash requirements made on multi-unit trains for passenger transport are met without having permanently to lengthen the head. Retrofitting of vehicles is also possible. A modular structure enables application for example on regional railways as well as on ICE vehicles.

The invention is explained below in greater detail with the aid of examples of embodiment.

### EXAMPLE 1

The front part of a multi-unit train is moved out against the travel direction by a distance of approx. 500 mm in the event of danger. The intermediate space created by moving out the front part is then filled at least partially, in particular fully, with energy absorption elements. Higher impact-energy amounts can thus be absorbed by making available an increased energy absorption path. An adaptation to the detected crash incident takes place. Passenger safety is thus increased.

The carriage body structure is damaged less or not at all, so that a subsequent repair time is shortened by simple replacement of absorber modules containing the energy absorption elements.

The front part capable of being moved out can contain only buffers or parts of the carriage body of the head module. In this example of embodiment, the whole front part from the lower edge of the windscreen, including the components installed below the front cowling, such as for example lighting, horn, nose cap swivelling mechanism, but not the coupling, is moved out against the travel direction by means of guide elements and actuators. At the same time, absorber elements, which in the specific case of application lie at the level of the buffers, are positioned in the intermediate space that has arisen.

The front part of a train is restricted not only to the front part of the train in the travel direction, since a crash can also take place on the rear part of the train in the travel direction.

### EXAMPLE 2

In addition to or alternatively to this, intermediate spaces existing at least between two neighbouring carriages of the train are filled at least partially, in particular fully, with energy absorption elements. Higher impact energy can thus be absorbed distributed over the train. An adaptation to the present crash incident is thus possible through the targeted activation of certain energy absorption elements and the targeted deactivation of the other energy absorption elements. Here too, passenger safety is thus increased. The carriage body structure is damage less or not at all, so that a subsequent repair time is shortened by simple replacement of absorber modules containing the energy absorption elements.

In order to take due account of the dynamic behaviour of the overall system, the use of the energy absorption elements takes place selectively, i.e. in the intermediate spaces lying closer to the impact side, a greater number of energy absorption elements are moved into the intermediate spaces and/or a higher force level of the energy absorption elements is made available than in the end area of the train. Uniform braking of all the carriages belonging to the train with a reduced level of acceleration and a uniform distribution of the kinetic energy to be absorbed thus takes place.

In this example of embodiment, there are four tubular energy absorption elements capable of being moved out, swivelled out and/or pushed out in the vicinity of the four corners on the end wall of the carriage body of each carriage. The selective use of the energy absorption elements takes place here by the fact that, depending on the requirement, only a part or all four energy absorption elements are positioned in the intermediate spaces. For example, after the first carriage all four energy absorption elements are activated, in the middle of the train only two and at the end of the train the coupling suffices to absorb impact energy.

It is also possible to adapt the activation of the number of energy absorption elements and/or their force level to the speed of the train and/or the speed of the relative motion between the train and the obstruction giving rise to a crash, e.g. an oncoming vehicle. At slow speeds, for example, none or only a small part of the energy absorption elements capable of being moved out, swivelled out and/or pushed out are activated, whereas at average speeds a part of the moveable energy absorption elements go into the intermediate spaces. At high speeds, a large part or all of the energy absorption elements are activated.

Apart from displaceable energy absorption elements, swivelling energy absorption elements are an example of such activatable energy absorption elements. The energy absorption element is placed in its position in a swivelling manner with the aid of leverage kinematics. The possibility thus arises of integrating the energy absorption element into an existing assembly space, for example in or on the carriage body. In this position, the energy absorption element is deactivated. When required, the energy absorption element is swung into a position in which the energy absorption element, in particular a tubular energy absorption element, is able to absorb the acting force axially. The swivelling energy absorption element is activated by an evaluation logic, which is ted with data of the current travel status, recognition of the environment, in particular recognition of obstructions, travel-route information and/or vehicles located in the vicinity. The swivelling energy absorption element is an energy absorption element to be activated reversibly, i.e. the energy absorption element can be swung back into the passive position during non-use or in the event of a false tripping. The vehicle can then continue its journey. In order to achieve guidance of the tubular energy absorption elements lying opposite one another in the event of a crash, the end surfaces of the tubular energy absorption elements colliding into one another are formed in such a way that a positive locking is achieved upon contact.

1. An impact-energy dissipation device for vehicles, in particular rail-bound vehicles, characterized by means for impact-energy absorption capable of being activated or deactivated, said means for impact-energy absorption consisting therein that, when the means for impact-energy absorption are activated, a front part of the vehicle is moved out, swivelled out and/or pushed out against the impact direction, in particular against the direction of travel, and the intermediate space created by the moving out, swivelling out and/or pushing out of the front part is then filled at least partially, in particular completely, with energy absorption elements, and/or that intermediate spaces existing at least between two neighbouring and spaced parts of the vehicle, in particular between two wagons of a train, are filled at least partially, in particular completely, with energy absorption elements.

2. The impact-energy dissipation device according to claim 1, characterised in that, when the means of impact-energy absorption are activated, the front part moved out, swivelled out and/or pushed out by a distance between 100 mm and 1000 mm, preferably approx. 500 mm, in particular by means of guide elements and actuators.

3. The impact-energy dissipation device according to claim 1 or 2, characterised in that the front part capable of being moved out, swivelled out and/or pushed out contains buffers and/or parts of the carriage body of the head module.

4. The impact-energy dissipation device according to any one of claims 1 to 3, characterised in that the front part capable of being moved out contains the front cowling and the signal elements, but not the front coupling.

5. The vehicle according to any one of claims 1 to 4, characterised in that the front part capable of being moved out, from the lower edge of the windscreen, contains the front cowling and the components installed thereunder, in particular lighting, horn, nose cap swivelling mechanism.

6. The impact-energy dissipation device according to any one of claims 1 to 5, characterised in that several energy absorption elements of a rail-bound vehicle can be activated selectively.

7. The impact-energy dissipation device according to claim 6, characterised in that in the intermediate spaces lying closer to the impact side, a greater number of energy absorption elements are moved out, swivelled out and/or pushed out into the intermediate spaces and/or a higher force level of the energy absorption elements is made available than in the end area of the rail-bound vehicle.

8. The impact-energy dissipation device according to claim 6 or 7, characterized in that the activation of the number of energy absorption elements and/or their force level is adapted to the speed of the rail-bound vehicle and/or the speed of the relative motion between the rail-bound vehicle and the obstruction giving rise to a crash, e.g. an oncoming vehicle.

9. The impact-energy dissipation device according to any one of claims 6 to 8, characterised in that at slow speeds none or only a small part of the energy absorption elements are activated and/or at average speeds a part of the energy absorption elements is activated and/or at high speeds all or a large part of the energy absorption elements are activated.

10. The impact-energy dissipation device according to any one of claims 1 to 9, characterized in that at least one of the energy absorption elements is placed in its position in a swivelling manner with the aid of leverage kinematics.

11. The impact-energy dissipation device according to claim 10, characterised in that the energy absorption element can, when activated, be swivelled into a position in which the energy absorption element, in particular a tubular energy absorption element, is able to take up the acting force axially.

12. The impact-energy dissipation device according to any one of claims 1 to 11, characterised in that the energy absorption element in the deactivated state is integrated into an existing assembly space, in particular in or on the carriage body.

13. The impact-energy dissipation device according to any one of claims 1 to 12, characterised in that at least one of the energy absorption elements is an energy absorption element to be activated reversibly.

14. The impact-energy dissipation device according to any one of claims 1 to 13, characterised in that the activation of the means of impact-energy absorption takes place by means of a switch.

15. The impact-energy dissipation device according to any one of claims 1 to 14, characterised in that the activation of the means of impact-energy absorption takes place by means of a switching device, which is coupled with existing safety systems, in particular an airbag and/or a braking assistant.

16. The impact-energy dissipation device according to any one of claims 1 to 15, characterised by means for the detection of an impending crash and the preparation of suitable data, means for the evaluation of the data, whereby the means of impact-energy absorption can be activated or deactivated in dependence on the evaluation of the data.

17. The impact-energy dissipation device according to claim 16, characterised in that the means of detection include sensor technology for the acquisition of data on the current travel status, recognition of the environment, in particular recognition of obstructions, travel-route information and/or vehicles located in the vicinity.

18. The impact-energy dissipation device according to claim 16 or 17, characterised in that the means of evaluation include an evaluation logic, which evaluates the data, assesses the situation and if need be triggers the means of impact-energy absorption.
